(19) United States
(12) Patent Application Publication
(10) Pub. No.: US 2005/0143237 A1
(43) Pub. Date: Jun. 30, 2005

(54) Tool magazine feeder for automatic tool changer

(75) Inventor: Sang Moon Ryu, Kimhae (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: DAEWOO HEAVY INDUSTRIES & MACHINERY LTD., Incheon (KR)

(21) Appl. No.: 11/008,668

(22) Filed: Dec. 10, 2004

(30) Foreign Application Priority Data
Dec. 27, 2003 (KR) 2003-98068

(51) Int. Cl. B23Q 3/157

(52) U.S. Cl. 483/54

(57) ABSTRACT

A tool magazine feeder for an automatic tool changer for feeding a tool magazine to a spindle comprises a carriage horizontally movable, under the state of supporting the tool magazine, between a remote position where the carriage is separated from the spindle and a proximate position where the carriage is adjacent to the spindle, a driving mechanism for reciprocating the carriage from the remote position to the proximate position and vice versa, and a guide mechanism positioned between the carriage and the driving mechanism. The guide mechanism is provided with one or more rollers and one or more rails for guiding the carriage to horizontally move between the remote position and the proximate position.

### BACKGROUND OF THE INVENTION

1. Field of the Invention

The present invention relates to a tool magazine feeder for an automatic tool changer, and in particular to a tool magazine feeder for an automatic tool changer designed to feed a tool magazine to a spindle.

2. Description of the Related Art

As is well known in the art, a machine tool, such as a numerical control lathe, a machining center, or the like, is adapted to accomplish cutting operation with the use of different kinds of tools. For this reason, the conventional machine tool is provided with an automatic tool changer (ATC) for changing one tool with another in an automated manner.

The automatic tool changer comprises a tool magazine 1 containing a plurality of tools T, and a feeder 5 capable of feeding the tool magazine 1 to a spindle 3 laterally spaced from the tool magazine 1, as shown in FIG. 1. In particular, the feeder 5 comprises a carriage 7 arranged to be horizontally movable on a frame 1a while supporting the tool magazine 1, and an actuator 8 for horizontally moving the carriage 7.

The carriage 7 moves along a pair of guide roads 7a mounted on the frame 1a, in which the carriage 7 reciprocates between a “remote position” C spaced from the spindle 3 and a “proximate position” D while horizontally moving along the guide rods 7a, thereby aligning the tool magazine 1 supported under the carriage 7 with the spindle 3 or spacing the tool magazine 1 from the spindle 3.

The actuator 8 consists of a pneumatic cylinder and moves the carriage 7 between the “remote position” C and the “proximate position” D while being extended and retracted by compressed air coming in and out the actuator 8.

Meanwhile, such a conventional tool magazine feeder 5 has a problem in that the tool magazine 1 cannot be correctly moved to a predetermined position due to the difficulty in precisely controlling the tool magazine feeder 5. Specifically, the conventional feeder 5 suffers from variation in pressure and amount of air coming in and out the actuator 8 each time, because the actuator 8 for moving the carriage 7 is operated by air which is a kind of compressible gas. Accordingly, the carriage 7 has a problem in that it cannot move to one and same “proximate position” D each time while moving between the “remote position” C and the “proximate position” D.

Such a problem makes it impossible to correctly align the tool magazine 1 with the spindle 1, thereby causing a malfunction.

Taking this into consideration, the carriage comprises a stopper 9 for limiting the carriage 7 at a predetermined position, so that the carriage 7 can stop at the same “proximate position” D each time. However, in such a case, there is a problem in that noise and impact are caused while the carriage runs into and interferes with the stopper 9.

Moreover, there is also a problem in that the carriage 7 may be abruptly operated or stopped when the pressure of the compressed air supplied to the actuator 8 is abruptly lowered or raised, whereby impact and noise are produced. Such a problem causes deterioration of endurance of the feeder 5.

In addition, the feeder 5 comprises an actuator 8 configured in a large capacity; because a large amount of compressed air is supplied to the actuator, air pressure supplied to another pneumatic device requiring a relatively large amount of compressed air may be affected, whereby the pneumatic device may be occasionally caused to malfunction.

Furthermore, there is a disadvantage in that as the guide roads 7a for guiding the carriage 7 are configured in a circular form and the-carriage 7 moving along the guide roads 7a are separately provided with bush-type bearings 7b, the feeder 5 is very complicate in construction and difficult to repair and assemble, and high precision is required for the feeder 5. In particular, there is a disadvantage in that because the guide roads 7a should be worked with high precision, a lot of time and costs are required to work the guide roads 7a.

### SUMMARY OF THE INVENTION

Accordingly, the present invention has been made to solve the above-mentioned problems inherent in the prior art, and it is an object of the present invention to provide a tool magazine feeder for an automatic tool changer that allows a tool magazine to be moved to a correct position, without noise and impact.

Another object of the present invention is to provide a tool magazine feeder for an automatic tool changer that can prevent abrupt movement and stopping of a tool magazine which would otherwise caused by unstable supply of compressed air.

Still another object of the present invention is to provide a tool magazine feeder for an automatic tool changer that does not adversely affect the pressure and amount of compressed air supplied to another pneumatic device by configuring a tool magazine to be movable without being supplied with compressed air.

In order to achieve the above-mentioned objects, there is provided a tool magazine feeder for an automatic tool changer for feeding a tool magazine to a spindle, comprising: a carriage horizontally movable, under the state of supporting the tool magazine, between a remote position where the carriage is separated from the spindle and a proximate position where the carriage is adjacent to the spindle; driving means for reciprocating the carriage from the remote position to the proximate position and vice versa; and guide means positioned between the carriage and the driving means, the guide means comprising one or more rollers and one or more rails for guiding the carriage to horizontally move between the remote position and the proximate position, wherein the driving means comprises: a forward/reverse motor with an output shaft; and an operation lever secured to the output shaft of the forward/reverse motor for pivoting movement between first and second positions, the operation lever adapted to push the carriage from the remote position to the proximate position when the lever is caused to pivot from the first position to the second position and push the carriage from the proximate position to the remote position when the lever is caused to pivot from the second position to the first position.

Preferably, a finger is formed at a tip end of the operation lever to directly push the carriage, and a vertical slot is formed in the carriage, wherein the finger is capable of being movably inserted into the vertical slot.

### BRIEF DESCRIPTION OF THE DRAWINGS

The above and other objects, features and advantages of the present invention will be more apparent from the following detailed description taken in conjunction with the accompanying drawings, in which:

FIG. 1 is a front elevational view of a tool magazine feeder for an automatic tool changer of the prior art;

FIG. 2 is a front elevational view of a tool magazine feeder for an automatic tool changer according to the present invention;

FIG. 3 is a cross-sectional view taken along the line III-III of FIG. 2;

FIG. 4 is a cross-sectional view showing a variant of the carriage guide part forming the inventive tool magazine feeder; and

FIGS. 5A to 5C are views showing the operation of the inventive tool magazine feeder.

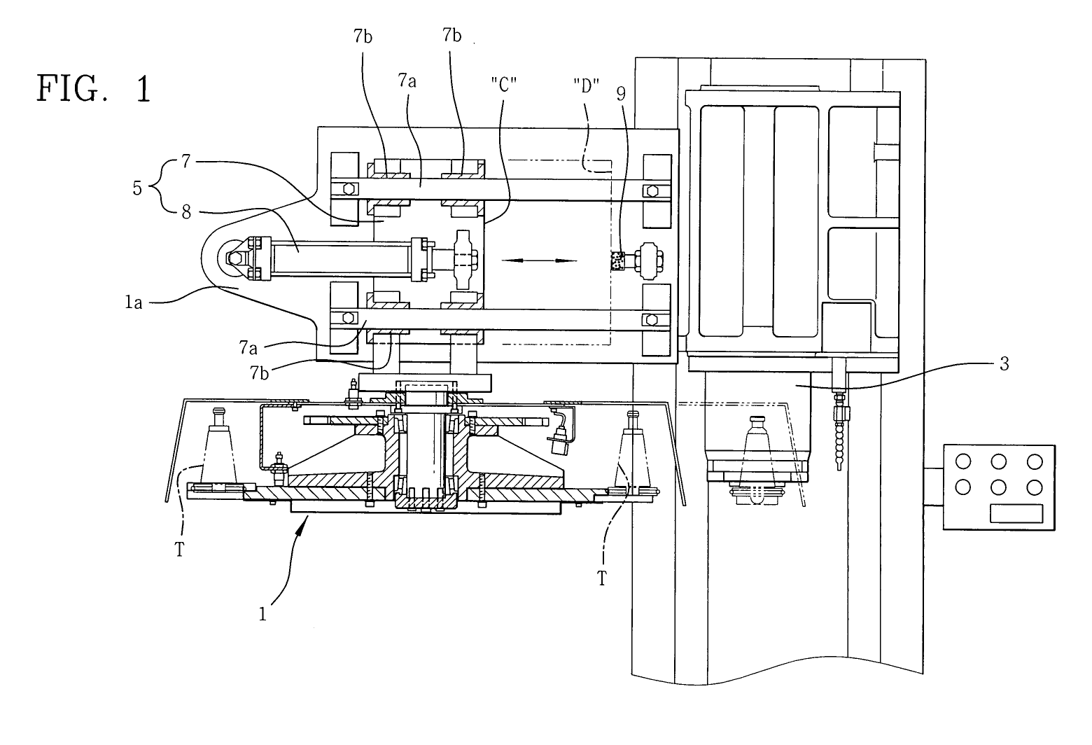

### DETAILED DESCRIPTION OF THE PREFERRED EMBODIMENTS

Hereinafter, preferred embodiments for a cooling device for a spindle built-in type spindle motor according to the present invention will be described with reference to the accompanying drawings. Components same with the conventional ones described above will be respectively indicated by the same reference numerals used in describing the prior art.

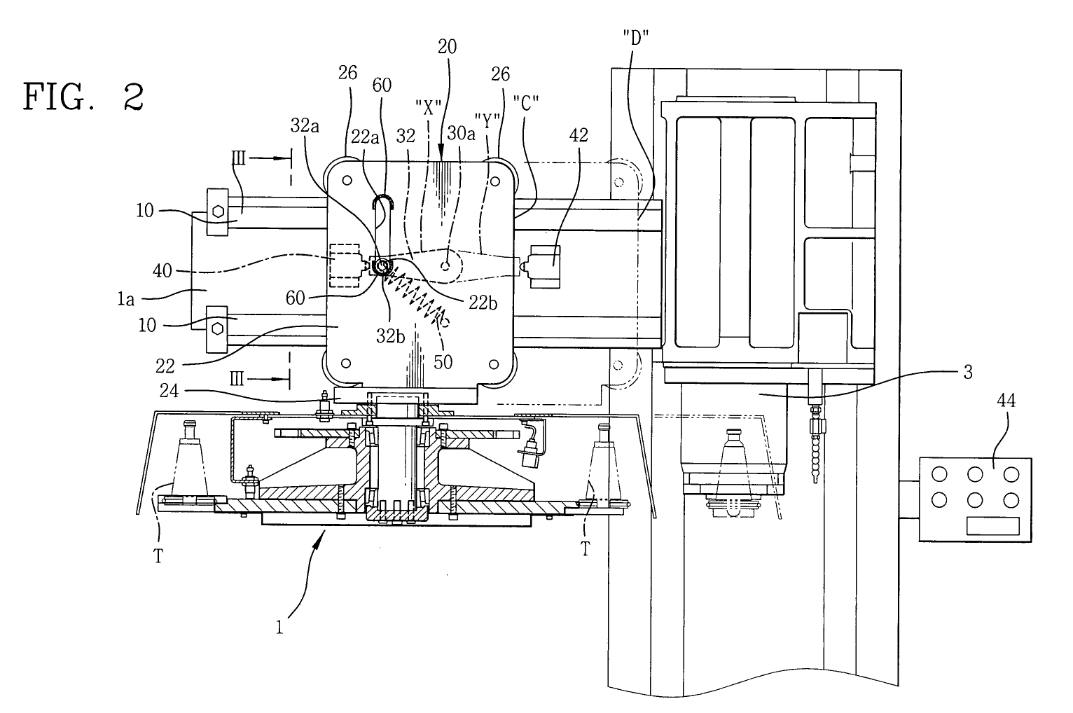

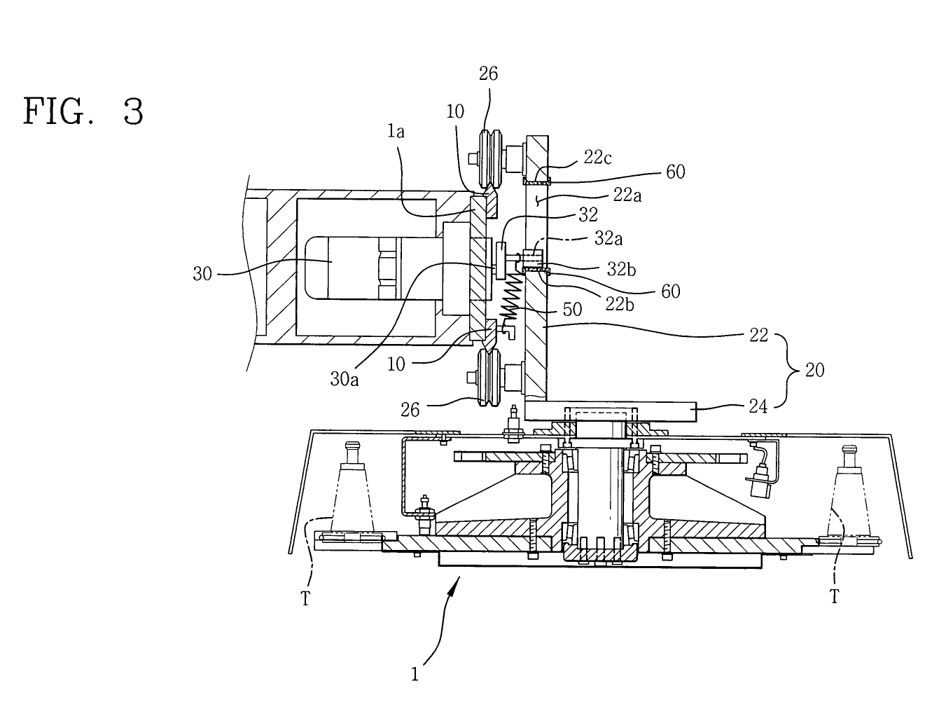

As shown in FIGS. 2 and 3, the inventive tool magazine feeder comprises a pair of guide rails 10 horizontally mounted on a frame 1a. The pair of guide rails 10 are provided in parallel and vertically spaced from each other.

In addition, the inventive tool magazine feeder has a carriage 20 horizontally moving along the guide rails 10. The carriage 20 consists of a vertical plate 22 movably mounted on the pair of guide rails 10 and a horizontal plate 24 secured to the lower end of the vertical plate 22 as shown in FIG. 3. In particular, a tool magazine 1 is mounted on the horizontal plate 24.

This carriage 20 horizontally moves along the guide rails 10 in the state of supporting the tool magazine 1. In particular, the carriage 20 reciprocates between a “remote position” C spaced from the spindle 3 and a “proximate position” D while horizontally moving along the guide rails 10, thereby aligning/spacing the tool magazine 1 supported below the tool magazine 1 with/from the spindle 3.

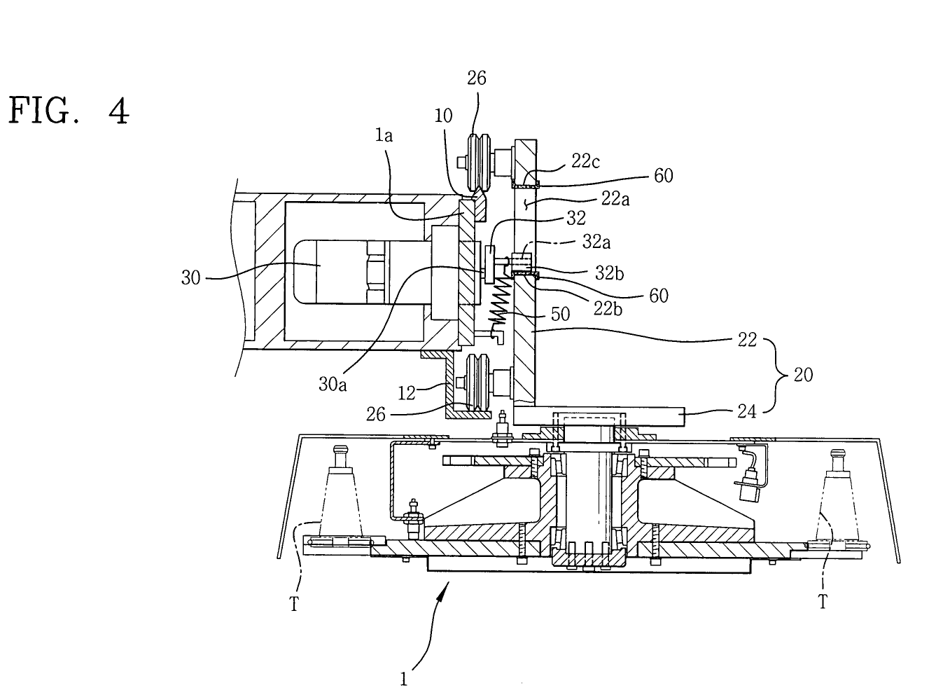

Meanwhile, the vertical plate 22 of the carriage 20 is provided with a plurality of rollers 26 to aid smooth movement along the guide rails 10. The guide rails 10 and the rollers 26 are guide means for guiding the horizontal movement of the carriage 20. Although FIGS. 2 and 3 show that the guide means for guiding the horizontal movement of the carriage 20 of the present invention consists of a pair of rollers 26 and a pair of guide rails 10 corresponding to the rollers 26, it is also possible that the upper part of the guide means is configured by a roller 26 and a rail 10 and the lower part is configured by a “L” shaped guide channel 12 and a roller 26 as shown in FIG. 4. Of course, it is also possible to use a “U” shaped guide channel in place of the “L” shaped guide channel 12.

Referring to FIGS. 2 and 3 again, the inventive tool magazine feeder comprises driving means for moving the carriage 20 from the “remote position” C to the “proximate position” D or from the “proxinate position” D to the “remote position” C.

The driving means comprises a forward/reverse motor 30 and an operation lever 32 secured to the output shaft 30a of the forward/reverse motor 30. In particular, the operation lever 32 is pivotally reciprocated between a “first position” X and a “second position” Y, wherein the operation lever 32 is arranged in such a way that it pushes the carriage 20 from the “remote position” C to the “proximate position” D while forwardly pivoting from the “first position” X to the “second position” Y and pushes the carriage 20 from the “proximate position” D to the “remote position” C while reversely pivoting from the “second position” to the “first position.”

Here, a finger 32a is projected from the tip end of the operation lever 32 to directly compress the vertical plate 22 of the carriage 20. A vertical slot 22a is formed in the vertical plate 22 of the carriage 20, in which slot the finger 32a of the operation lever 32 is supported to be vertically movable as well as rotatable. Meanwhile, the finger 32a of the operation lever 32 is provided with a rolling roller 32b so that the finger 32a and the vertical slot 22a smoothly come into contact with each other.

According to the driving means configured as described above, by pivoting the operation lever 32 with the forward/reverse motor 30 and horizontally reciprocating the carriage 20 with the operation lever 32, it is possible to reciprocate the carriage 20 from the “remote position” C to the “proximate position” D and from the “proximate position” D to the “remote position” C.

Meanwhile, on the way of pivoting between the “first position” X and the “second position” Y, the operation lever 32 is forwardly/reversely pivoted to a position where the finger 32a formed at the tip end of the operation lever is engaged with the lower end 22b of the vertical slot 22a of the carriage 20.

Referring to FIG. 2 again, the inventive tool magazine feeder comprises motor control means for stopping the forward/reverse motor 30 when the operation lever 32 is pivoted to the “first position” X or the “second position” Y.

The motor control means comprises a first detection sensor 40 for detecting whether the operation lever 32 is located at the “first position” X, a second detection sensor 42 for detecting whether the operation lever 32 is located at the “second position” Y, and a controller 44 for stopping the forward/reverse motor 30 in response to the detection signals inputted from the first and second detection sensors 40, 42.

With the motor control means, by stopping the forward/reverse motor 30 after the operation lever 32 moving to the “first position” X or the “second position” Y is detected, it is possible to allow the operation lever 32 to correctly stop at the “first position” X or the “second position” Y. In particular, by allowing the operation lever 32 to correctly stop at the “first position” X or the “second position” Y, it is possible to allow the carriage 20 moved by the operation lever 32 to be correctly fixed at the “remote position” C or the “proximate position” D.

Meanwhile, although it has been described that the present invention controls the position of the operation lever 32 with the aid of the first detection sensor 40, the second detection sensor 42 and the controller 44, it is possible to directly control the operation lever 32 by fabricating the forward/reverse motor 30 itself as a servo-motor.

Referring to FIGS. 2 and 3 again, the inventive tool magazine feeder includes vibration suppression means for preventing the finger 32a at the tip end of the operation lever 30 from vibrating as the finger 32a runs into the lower end 22b of the vertical slot 22a of the carriage while the operation lever 32 rapidly pivots from the “first position” X to the “second position” Y or from the “second position” Y to the “first position” X.

The vibration suppression means consists of a spring 50, one end of which is supported by the frame 1a and the other end of which is supported by the finger 32a of the operation lever 30. The spring 50 resiliently supports downwardly the operation lever 32 pivoting to the “first position” X or the “second position” Y, wherein the spring 50 serves to urge the finger 32a of the operation lever 32a against the lower end 22b of the vertical lever 22a. In particular, by urging the finger 32a of the operation lever 32 against the lower end 22b of the vertical slot 22a, the operation lever 32 is prevented from bounding and vibrating by the contact between the finger 32a and the lower end 22b of the vertical slot 22b.

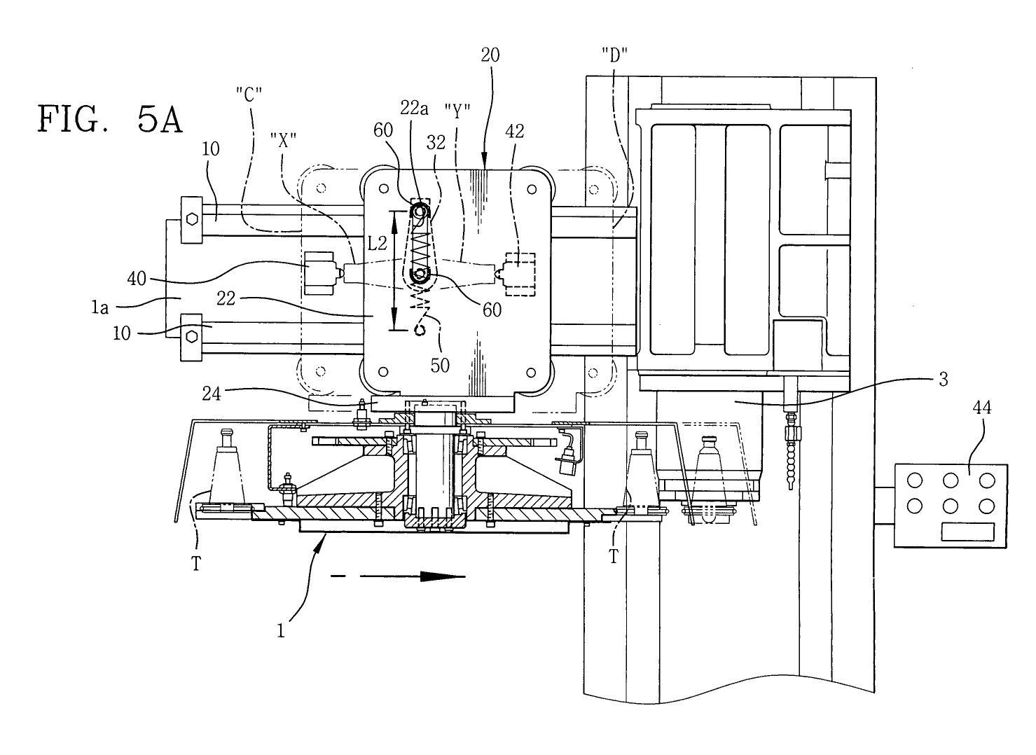

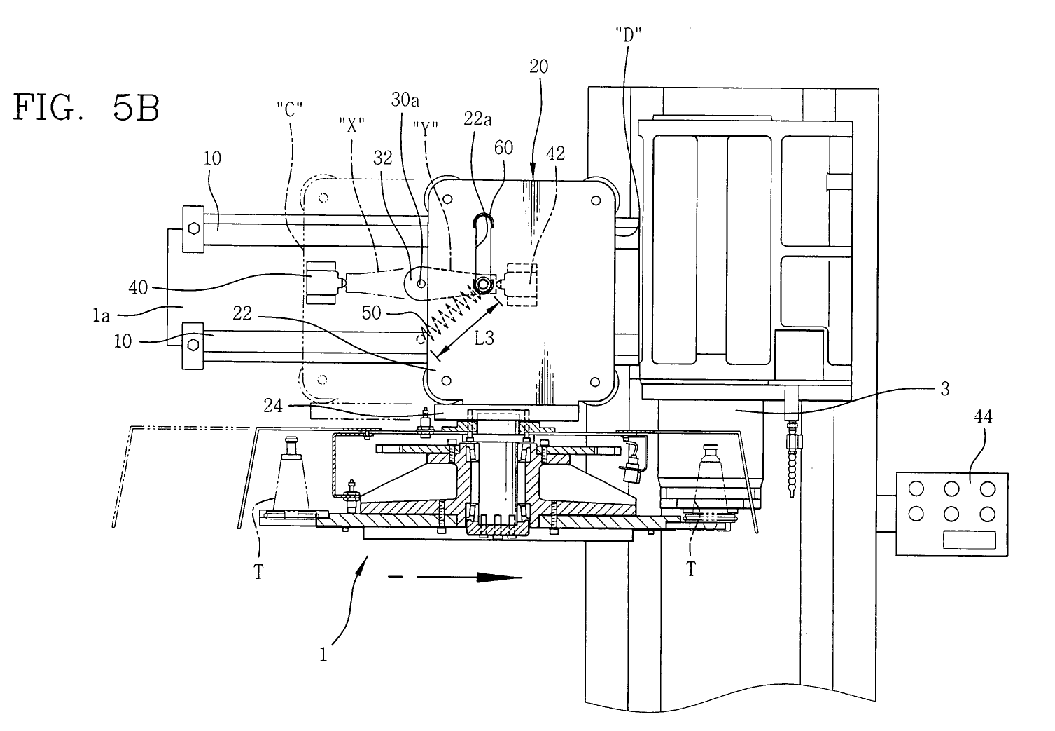

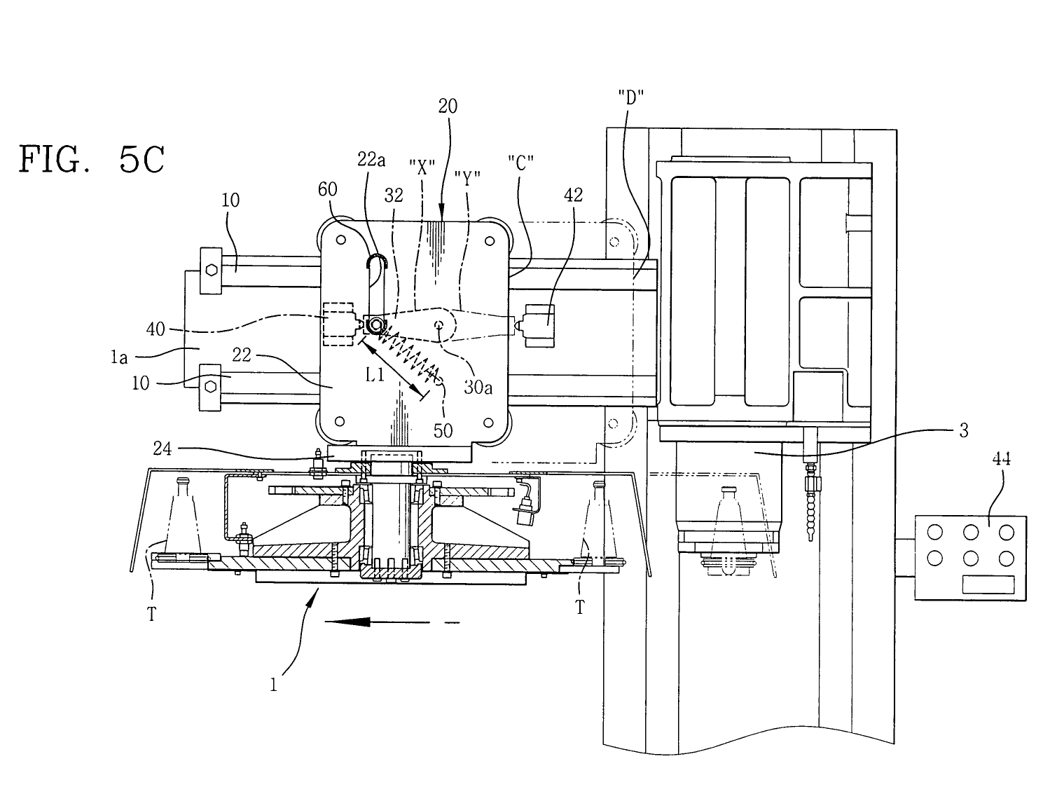

Beyond suppressing the vibration of the operation lever 32, the spring 50 also resiliently supports downwardly the operation lever 32 pivoting to the “first position” X or the “second position” Y as shown in FIGS. 5B and 5C, thereby serving to accelerate the pivoting velocity of the operation lever 32. As a result, the carriage 20 is caused to move in a high velocity.

Meanwhile, the spring 50 is supported by the frame 1a at its one end as shown in FIG. 2, wherein the supporting point is aligned to the rotational center 32, that is, to the vertical lower part of the output shaft 30a of the forward/reverse motor 30.

This arrangement is provided for several purposes as follows: to render the spring 50 to have the longest tensioning length L2 when it supports the operation lever 32 positioned at the middle position between the “first position” X and the “second position” Y as shown in FIG. 5A, so that larger elastic force is applied to the operation lever 32 so as to cause the operation lever 32 to more rapidly pivot, and to render the spring 50 to have the shortest tensioning length L1, L3 when it supports the operation lever 32 positioned at the “first position” X or the “second position” Y, so that relatively smaller elastic force is applied to the operation lever 32 so as to minimize the impact against the lower end 22b of the slot 22a.

Referring to FIGS. 2 and 3 again, the inventive tool magazine further comprises a pair of shock-absorbing pads 60 each being provided at the lower end 22b and upper end 22c of the vertical slot 22a of the carriage 20. The shock-absorbing pads 60 are arranged in such a way that they come into contact with the rolling roller 32a of the operation lever 32 pivoting from the “first position” X to the “second position” Y, or from the “second position” Y to the “first position” X. Consequently, the shock-absorbing pads 60 prevent the rolling roller 32b of the operation lever 32, which rapidly pivots, from vibrating when the roller 32b runs into the lower end 22b and the upper end 22c of the vertical slot 22a of the carriage 20.

Next, the functional action of the invention configured as described above is described with reference to FIGS. 2 and 5A to 5C. At first, if a tool exchanging command is given in the state in which the carriage 20 is positioned at the “remote position” C as shown in FIG. 2, the forward/reverse motor 30 of the driving means is operated and forwardly rotated.

Then, as the forward/reverse motor 30 is forwardly rotated, the operation lever 32 is also forwardly rotated as shown in FIG. 5A, thus moving from the “first position” X to the “second position” Y. At this time, as the operation lever 32 moves from the “first position” X to the “second position” Y, the carriage 20 also moves from the “remote position” C toward the “proximate position” D, and as the carriage 20 moves from the “remote position” C toward the “proximate position” D, the tool magazine supported on the carriage 20 also moves toward the spindle 3.

Then, as the operation lever 32 continuously pivots in the forward direction and arrives at the “second position” Y as shown in FIG. 5B and the carriage 20 arrives at the “proximate position” D, the tool magazine 1 supported on the carriage 20 is aligned to the lower part of the spindle 3. In this state, the tool T supported on the spindle 3 is in the state of being exchangeable.

Meanwhile, if the operation lever 32 arrives at the “second position” D, the second detection sensor 42 detects it and input a detection signal to the controller 44. Then, the controller 40 recognizes that the operation lever 32 is located at the “second position” and stops the operation of the forward/reverse motor 30 in response to the inputted signal. Accordingly, the operation lever 32 is fixed at the “second position” Y, as a result of which the carriage 20 is also fixed at the “proximate position” D.

Meanwhile, if the exchange of the tool T is completed, the forward/reverse motor 30 of the driving means is reversely rotated. Then, as the forward/reverse motor 30 is reversely rotated, the operation lever 32 secured to the forward/reverse motor 30 also reversely pivots as shown in FIG. 5C, thus moving from the “second position” Y to the “first position” X. At this time, as the operation lever 32 moves from the “second position” Y to the “first position” X, the carriage 20 also moves from the “proximate position” D toward the “remote position” C, and as the carriage 20 moves from the “proximate position” D toward the “remote position” C, the tool magazine 1 supported on the carriage 20 is moved away from the spindle 3.

Then, if the operation lever 32 continuously pivots in the reverse direction and arrives at the “first position” X, the carriage 20 also arrives at the “remote position” C, and as the carriage 20 arrives at the “remote position” C, the tool magazine 1 supported on the carriage 20 is completely separated from the spindle 3.

Meanwhile, if the operation lever 32 arrives at the “first position” X and the first sensor 40 detects this, the sensor 40 inputs the detection sensor to the controller 44. Then, the controller 44 recognizes that the operation lever 32 is positioned at the “first position” X and stops the operation of the forward/reverse motor 30. Consequently, the operation lever 32 is fixed at the “first position” X, as a result of which the carriage 20 is also fixed at the “remote position” C.

As the inventive tool magazine feeder for an automatic tool changer configured as described above fees the tool magazine using a motor, it is possible to prevent the tool magazine from abruptly moving and abruptly stopping due to the unstable supply of compressed air as in the prior art. In addition, because the tool magazine can be moved without being supplied with compressed air, the movement of the tool magazine does not affect the pressure and supplied amount of the compressed air supplied to another pneumatic device. Furthermore, because the tool magazine can be moved to a correct position each time without noise and impact, the tool exchange can be precisely controlled. Moreover, the construction of the inventive tool magazine feeder is very simple, it is possible to reduce the manufacturing costs thereof and it is simple and convenient to assemble or repair the tool magazine feeder.

While the invention has been shown and described with reference to certain preferred embodiments thereof for the purpose of exemplification, the present invention is not limited to the specific embodiment. It will be understood by those skilled in the art that various changes in form and details may be made therein without departing from the spirit and scope of the invention as defined by the appended claims.

1. A tool magazine feeder for an automatic tool changer for feeding a tool magazine to a spindle, comprising:
a carriage horizontally movable, under the state of supporting the tool magazine, between a remote position where the carriage is separated from the spindle and a proximate position where the carriage is adjacent to the spindle;
driving means for reciprocating the carriage from the remote position to the proximate position and vice versa; and
guide means positioned between the carriage and the driving means, the guide means comprising one or more rollers and one or more rails for guiding the carriage to horizontally move between the remote position and the proximate position,
wherein the driving means comprises: a forward/reverse motor with an output shaft; and an operation lever secured to the output shaft of the forward/reverse motor for pivoting movement between first and second positions, the operation lever adapted to push the carriage from the remote position to the proximate position when the lever is caused to pivot from the first position to the second position and push the carriage from the proximate position to the remote position when the lever is caused to pivot from the second position to the first position.

2. A tool magazine feeder as claimed in claim 1, wherein a finger is formed at a tip end of the operation lever to directly push the carriage, and a vertical slot is formed in the carriage, wherein the finger is capable of being movably inserted into the vertical slot.

3. A tool magazine feeder as claimed in claim 2, wherein the pivotal movement of the operation lever is limited at the first and second positions as the finger is engaged with the lower end of the vertical slot.

4. A tool magazine feeder as claimed in claim 2, further comprising vibration suppression means for preventing the operation lever from vibrating as the finger runs into the lower end of the vertical slot while the operation lever pivots between the first and second positions, wherein the vibration suppression means is a spring resiliently compressing the operation lever that has pivoted to the first position or the second position in the direction to urge the operation lever against the lower end of the vertical slot.

5. A tool magazine feeder as claimed in claim 2, further comprising vibration suppression means for preventing the operation lever from vibrating as the finger runs into the lower end of the vertical slot while the operation lever pivots between the first and second positions, wherein the vibration suppression means is a spring resiliently compressing the operation lever that has pivoted to the first position or the second position in the direction to urge the operation lever against the lower end of the vertical slot.

6. A tool magazine feeder as claimed in claim 4, wherein the opposite ends of the vertical slot are respectively provided with shock-absorbing pads.

7. A tool magazine feeder as claimed in claim 1, further comprising motor control means for stopping the forward/reverse motor at the time when the operation lever pivots to the first position or the second position, wherein the motor control means comprises: a first detection sensor for detecting whether the operation lever is positioned at the first position, a second detection lever for detecting whether the operation lever is positioned at the second position, and a controller for stopping the forward/reverse motor in response to the signals inputted from the first and second detection sensors.

8. A tool magazine feeder as claimed in claim 1, wherein the guide means comprises a pair of rollers which are vertically arranged and a pair of guide rails corresponding to the rollers.

9. A tool magazine feeder as claimed in claim 1, wherein the guide means comprises an upper part consisting of a roller and a guide rail and a lower part consisting of a guide channel and a guide roller.
